(19) United States
(12) Patent Application Publication
(10) Pub. No.: US 2019/0360540 A1
(43) Pub. Date: Nov. 28, 2019

(54) ONE-WAY ROTATING DEVICE

(71) Applicant: Wonderides, Inc., Mercer Island, WA (US)

(72) Inventor: Tianfang LING, Mercer Island, WA (US)

(21) Appl. No.: 15/986,264

(22) Filed: May 22, 2018

(51) Int. Cl. F16D 59/00; F16D 49/00

(52) U.S. Cl. CPC F16D 59/00; F16D 2121/14; F16D 49/00

(57) ABSTRACT

A one-way rotating device includes a wheel configured to rotate about a center axis thereof toward a front side or a rear side of the wheel; a wheel bracket mounted to the wheel; and a stop ring mounted to the wheel bracket at a fixed position above the center axis of the wheel and contacting a circumferential surface of the wheel on the front side or the rear side of the wheel. The stop ring is configured to stop the wheel from rotating in a direction toward the front side or the rear side.

### RELATED APPLICATIONS

The following US applications are related to the instant application and are incorporated by reference herein:
US patent application titled “Ride-on Toy,” Attorney Docket No. 6146-0001, invented by Tianfang LING; and
US patent application titled “Steering Device,” Attorney Docket No. 6146-0003, invented by Tianfang LING.

### TECHNICAL FIELD

The present disclosure relates to a one-way rotating device, and more particularly, to a one-way wheel to be installed on various movable apparatuses, e.g., a ride-on toy.

### BACKGROUND

Universal wheels are installed to most toys so that the toys can move both forward and rearward. However, such universal wheels are not suitable in toys, e.g., ride-on toys, which are intended to move in a single direction. Thus, the inventor(s) propose(s) a rotating wheel that only rotates in one direction.

### BRIEF DESCRIPTION OF THE DRAWINGS

One or more embodiments are illustrated by way of example, and not by limitation, in the figures of the accompanying drawings, wherein elements having the same reference numeral designations represent like elements throughout.

FIG. 1 is an exploded view of a one-way rotating device according to at least one embodiment.

FIG. 2 is a perspective view of the one-way rotating device in an assembled state according to the at least one embodiment.

FIG. 3 is a side view of the one-way rotating device in an assembled state according to the at least one embodiment.

FIG. 4 is a side view of a one-way rotating device in an assembled state according to an example of the at least one embodiment.

### DETAILED DESCRIPTION

The disclosure herein provides many different embodiments, or examples, for implementing different features of the disclosed subject matter. Specific examples of components and arrangements are described below to simplify the present disclosure. These are examples and are not intended to be limiting.

This description of the various embodiments is intended to be read in connection with the accompanying drawings, which are to be considered part of the entire written description. In the description, relative terms such as “left,” “right,” “before,” “after,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the system be constructed or operated in a particular orientation. For example, for convenience of description and in connection with the accompanying drawings, a wheel of the one-way rotating device described in this application is controlled by a stop ring to rotate in a direction toward a front side or a rear side, depending on the location of the stop ring with respect to the wheel. The wheel of the one-way rotating device described in this application is controlled by the stop ring to rotate in one direction only, not limited to the direction toward the front side or the direction toward the rear side. Terms concerning attachments, coupling and the like, such as “connected” and “interconnected,” refer to a relationship wherein components are attached to one another either directly or indirectly through intervening components, unless expressly described otherwise.

According to the embodiment(s) described herein, it is possible to provide a one-way rotating device which has a simple structure and low manufacturing cost for an apparatus that only moves in one direction. The one-way rotating device in some embodiments is used as a single-way wheel, which is configured to rotate in only one direction, in a ride-on toy such as a ride-on toy as described in US patent application titled “Ride-On Toy,” Attorney Docket No. 6146-0001, invented by Tianfang LING, which application is incorporated by reference herein.

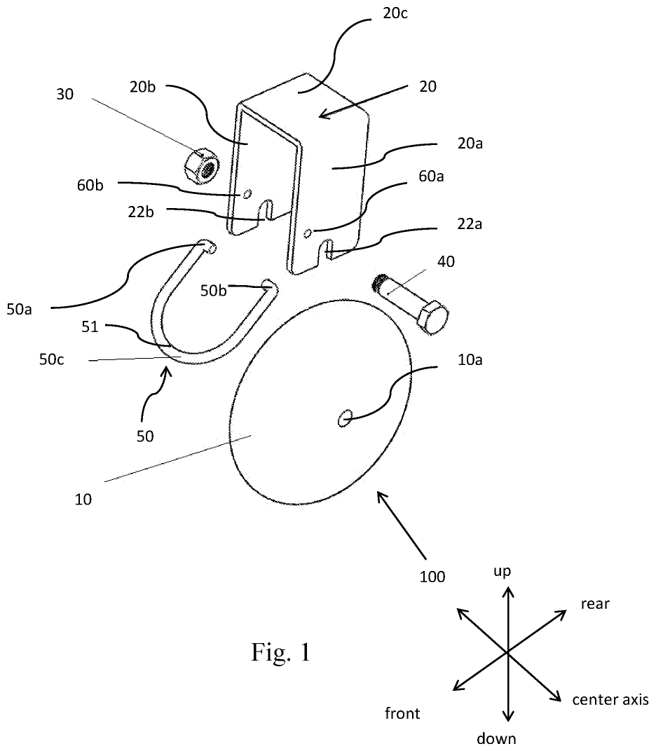

FIGS. 1-3 show a one-way rotating device 100 according to the at least one embodiment. As shown in FIG. 1, the one-way rotating device 100 has a front-rear direction, an up-down direction, and an axial direction perpendicular to the front-rear direction and the up-down direction. The one-way rotating device 100 includes a rotatable member, e.g., wheel 10, a mounting member, e.g., wheel bracket 20, and a stop mechanism, e.g., a stop ring 50.

The wheel 10 has a through hole at a center axis 10a extending along the axial direction. The wheel 10 is rotatable about the center axis 10a in a single direction.

The wheel bracket 20 is mounted to the wheel 10. The wheel bracket 20 has an inverted U-shape. The wheel bracket 20 includes substantially straight side portions 20a and 20b and a generally horizontal connection portion 20c connecting the side portions 20a and 20b. The side portions 20a and 20b are integrally formed with the connection portion 20c. The side portions 20a and 20b have a pair of cutouts 22a and 22b and a pair of openings 60a and 60b. The pair of cutouts 22a and 22b is coaxially arranged with the center axis 10a of the wheel 10 in the axial direction. The pair of openings 60a and 60b is located on a front side and on an upper side of the pair of cutouts 22a and 22b. In some embodiments, the location of the pair of openings 60a and 60b is on a rear side of the pair of cutout 22a and 22b.

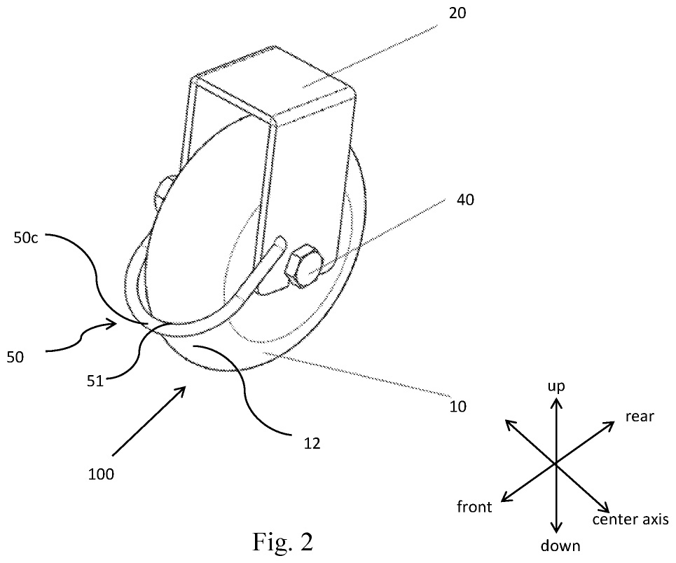

Further, the wheel bracket 20 is mounted to the wheel 10 at the center axis 10a by at least one fixing element. For example, in FIGS. 1-2, the side portions 20a and 20b of the wheel bracket 20 are fixed to opposite sides of the wheel 10 at the center axis 10a by a nut 30 and a bolt 40 extending through the through hole of the wheel 10.

The stop ring 50 is rotatably mounted to the wheel bracket 20. The stop ring 50 has an inner surface corresponding to a circumferential surface 12 of the wheel 10. As shown in FIGS. 1-2, the stop ring 50 is formed of a U-shape. The stop ring 50 has two end portions 50a and 50b and an intermediate portion 50c connecting the two end portions 50a and 50b. The two ends portions 50a and 50b of the stop ring 50 extend toward each other and are rotatably fixed into the openings 60a and 60b of the side portions 20a and 20b, respectively, to mount the stop ring 50 to the wheel bracket 20. Further, the intermediate portion 50c of the stop ring 50 has an inner surface 51 of the intermediate portion 50c. According to at least one embodiment, the inner surface 51 is in a form of an arc.

As shown in FIG. 2, when the stop ring 50 is mounted to the wheel bracket 20 by the bolt 40 and nut 30, the stop ring 50 is placed on the wheel 10 by its gravity and the inner surface 51 of the intermediate portion 50c is in direct contact with the circumferential surface 12 of the wheel 10.

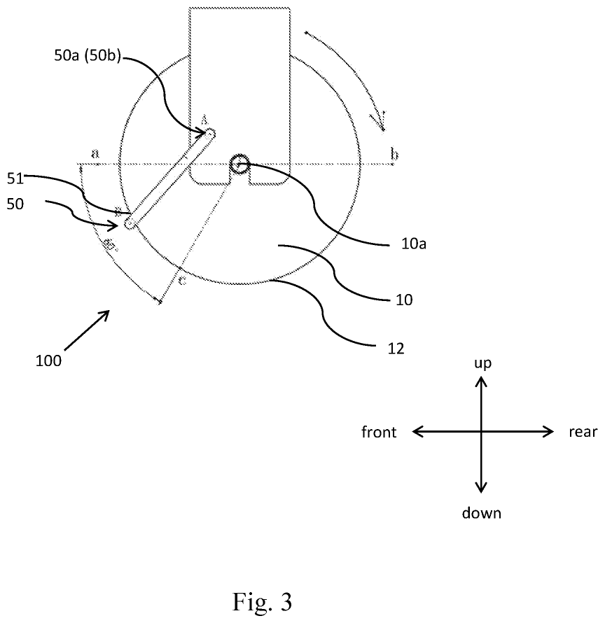

FIG. 3 shows a side view of the one-way rotating device 100. As shown in FIG. 3, the end portions 50a and 50b of the stop ring 50 are coaxially located at position A, and the inner surface 51 of the intermediate portion 50c of the stop ring 50 is in direct contact with the circumferential surface 12 of the wheel 10 on the front side of the wheel at position B.

In FIG. 3, the wheel 10 is divided into first and second halves by an imaginary horizontal line a-b extending in the front-rear direction. The first half of the wheel 10 is on the upper side of the second half of the wheel 10.

The position A where the end portions 50a and 50b of the stop ring 50 are fixed to the wheel bracket 20 can be set at any point in the first half of the wheel 10, e.g., in an area above the horizontal line a-b. In other words, the end portions 50a, 50b of the stop ring 50 can be fixed to the wheel bracket 20 at any point as long as the point is in the first half the wheel 10 on an upper side of the center axis 10a of the wheel 10. In the at least one embodiment shown in FIG. 3, the position A is set on the upper side and on the front side of the center axis 10a. In some embodiments, the position A can be set on the upper side and on the rear side of the center axis 10a.

The position B is a contact position, at which the inner surface 51 of the intermediate portion 50c of the stop ring 50 directly contacts the circumferential surface 12 of the wheel 10 when the stop ring 50 is placed on the wheel 10 by its gravity. The position B can be set at any point in the bottom half of the wheel 10 within an angle of 60° from the horizontal line a-b. The range of the angle 60° is shown between the horizontal line a-b and a straight line connecting point c and a point at the center axis 10a.

The intermediate portion 50c has a section extending from position A to position B, and the section intersects the horizontal line a-b as shown in FIG. 3.

According to the configuration of the one-way rotating device 100 as shown in FIGS. 1-3, the stop ring 50 stops the wheel 10 from rotating in a counter clockwise direction toward the front side of the wheel 10 and permits the wheel 10 to rotate only in the clockwise direction toward the rear side of the wheel 10. The movement of the one-way rotating device 100 is described in details below.

According to FIGS. 1-3, when there is an attempt, e.g., by a user, to rotate the one-way rotating device 100 in a clockwise direction toward the rear side of the wheel 10, the wheel 10 rotates about the center axis 10a between the side portions 20a and 20b of the wheel bracket 20. A friction between the inner surface 51 of the intermediate portion 50c of the stop ring 50 and the outer circumferential surface 12 of the wheel 10 does not stop the wheel 10 from rotating in the clockwise direction toward the rear side of the wheel 10. After the wheel 10 starts to rotate, when a rotation speed of the wheel 10 is increased, the stop ring 50 starts to repeatedly bounce away from and toward the wheel 10 during rotation of the wheel 10. Even when the stop ring 10 contacts the circumferential surface 12 of the wheel 10 at position B on the front side of the wheel 10 as shown in FIG. 3, the stop ring 50 still allows the wheel 10 to rotate in the clockwise direction toward the rear side.

When there is an attempt, e.g., by a user, to rotate the one-way rotating device 100 in a counter clockwise direction toward the front side of the wheel 10, the stop ring 50 holds the wheel 10 at position B to stop the wheel 10 from rotating. That is, the stop ring 50 exerts a stopping force against the wheel 10 at position B where the inner surface 51 of the intermediate portion 50c is in direct contact with the circumferential surface 12 of the wheel 10 to stop the wheel 10 from rotating in the counter clockwise direction. As a result, when the stop ring 10 contacts the circumferential surface 12 of the wheel 10 at position B on the front side of the wheel 10 as shown in FIG. 3, the stop ring 50 stops the wheel 10 from rotating in the counter clockwise direction toward the front side.

In a modified embodiment (not shown in drawings), the end portions 50a and 50b of the stop ring 50 are coaxially located at a position above the center axis 10a, and the inner surface 51 of the intermediate portion 50c of the stop ring 50 is in direct contact with the circumferential surface 12 of the wheel 10 at a position on the rear side of the wheel 10. According to this modified embodiment, when the stop ring 50 contacts the circumferential surface 12 of the wheel 10 on the rear side of the wheel, the stop ring 50 stops the wheel 10 from rotating in the clockwise direction toward the rear side of the wheel 10 and allows the wheel 10 to rotate in the counter clockwise direction toward the front side of the wheel 10.

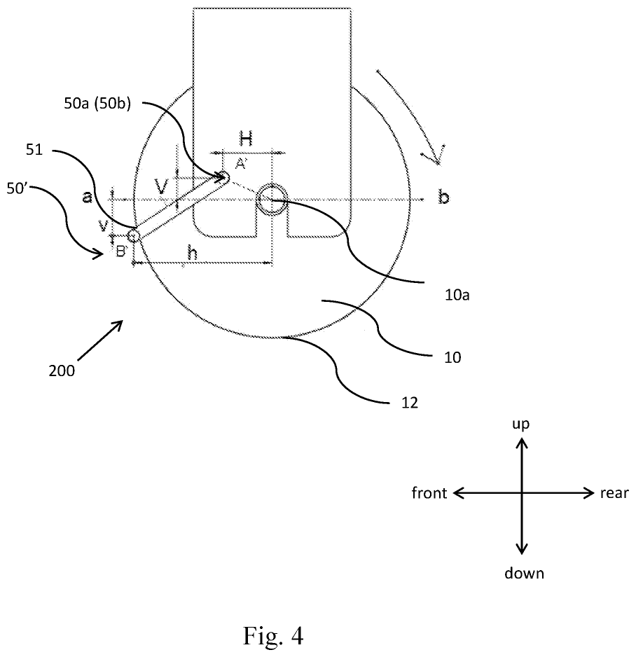

FIG. 4 shows a side view of a one-way rotating device 200 whish is a specific example according to the at least one embodiment. Compared with the at least one embodiment of FIG. 3, the stop ring 50′ of the one-way rotating device 200 in FIG. 4 is located at a different position. The end portions 50a and 50b of the stop ring 50′ are located at position A′, and the inner surface 51 of the intermediate portion 50c of the stop ring 50 is in direct contact with the circumferential surface 12 of the wheel 10 at position B′.

The position A′ is set in the first half of the wheel 10 above the horizontal line a-b. The position B′ is in the second half of the wheel 10 below the horizontal line a-b. The position B′ is set within an angle of 45° from the horizontal line a-b. The wheel 10 has a diameter in a range of 50 mm-500 mm. A horizontal distance H between the position A′ and the center axis 10a of the wheel 10 is in a range of 0-240 mm. A vertical distance V between the position A′ and the center axis 10a of the wheel 10 is in a range of 5 mm-260 mm. A horizontal distance h between the position B′ and the center axis 10a of the wheel 10 is in a range of 0-240 mm, and a vertical distance h between the position B′ and the center axis 10a of the wheel 10 is in a range of 10 mm-230 mm.

In an example of the one-way rotating device 200, the position A′ is set such that a horizontal distance H between the position A′ and the center axis 10a is 12.5 mm and a vertical distance V between the position A′ and the center axis 10a is 5.5 mm. In the same example, the position B′ is set such that a horizontal distance h between the position B′ and the center axis 10a is 35 mm, and a vertical distance v between the position B′ and the center axis 10a is 9 mm. The diameter of the wheel 10 is 80 mm. According to this configuration of the one-way rotating device 200 as shown in FIG. 4, the stop ring 50′ stops the wheel 10 from rotating in the counter clockwise direction toward the front side of the wheel 10 and permits the wheel 10 to rotate only in the clockwise direction toward the rear side of the wheel 10.

The one-way rotating device according to the disclosed embodiment(s) can be employed in various apparatus which requires one-way movement.

In accordance with one embodiment, a one-way rotating device includes a wheel configured to rotate about a center axis thereof toward a front side or a rear side of the wheel; a wheel bracket mounted to the wheel; and a stop ring mounted to the wheel bracket at a fixed position above the center axis of the wheel and contacting a circumferential surface of the wheel on the front side or the rear side of the wheel, wherein the stop ring is configured to stop the wheel from rotating in a direction toward the front side or the rear side.

In accordance with another embodiment, a one-way rotating device includes a rotatable member configured to rotate about a center axis thereof in a first direction, a mounting member mounted to the rotatable member, and a stop mechanism mounted to the rotatable member above the center axis at a fixed position and contacting a circumferential surface of the rotatable member to stop the rotatable member from rotating in a second direction, the second direction being opposite to the first direction.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A one-way rotating device, comprising:
a wheel configured to rotate about a center axis thereof toward a front side or a rear side of the wheel;
a wheel bracket mounted to the wheel; and
a stop ring rotatably mounted to the wheel bracket at a fixed position above the center axis of the wheel, and contacting a circumferential surface of the wheel on the front side or the rear side of the wheel to stop the wheel from rotating in a direction toward the front side or the rear side.

2. The one-way rotating device according to claim 1, wherein
when the stop ring contacts the circumferential surface of the wheel on the front side of the wheel, the stop ring is configured to stop the wheel from rotating in the direction toward the front side and allow the wheel to rotate in the direction toward the rear side.

3. The one-way rotating device according to claim 1, wherein
when the stop ring contacts the circumferential surface of the wheel on the rear side of the wheel, the stop ring is configured to stop the wheel from rotating in the direction toward the rear side and allow the wheel to rotate in the direction toward the front side.

4. The one-way rotating device according to claim 1, wherein the stop ring is in direct contact with the circumferential surface of the wheel by gravity.

5. The one-way rotating device according to claim 1, wherein the stop ring has a U-shaped configuration including
two end portions rotatably mounted to the wheel bracket at the fixed position, and
an intermediate portion connecting the two end portions and in direct contact with the circumferential surface of the wheel.

6. The one-way rotating device according to claim 5, wherein the intermediate portion of the stop ring has an inner surface configured to directly contact the circumferential surface of the wheel to stop the wheel from rotating in the direction toward the front side or the rear side.

7. The one-way rotating device according to claim 6, wherein the inner surface of the intermediate portion of the stop ring has an arc shape corresponding to the circumferential surface of the wheel.

8. The one-way rotating device according to claim 5, wherein
the wheel is divided into a top half and a bottom half by an imaginary horizontal line perpendicular to the center axis, and
the intermediate portion of the stop ring is in direct contact with the circumferential surface of the wheel at a position within an angle of 60° from the imaginary horizontal line.

9. The one-way rotating device according to claim 8, wherein
the two end portions of the stop ring are rotatably mounted to the wheel bracket at the fixed position in the top half of the wheel, and
the intermediate portion of the stop ring is in direct contact with the circumferential surface of the wheel at the position in the bottom half of the wheel.

10. The one-way rotating device according to claim 1, wherein the wheel bracket includes
a pair of cutouts at the center axis of the wheel and receiving a fixing element to fix the wheel bracket to the wheel, and
a pair of openings above the pair of cutouts and receiving two ends of the stop ring.

11. The one-way rotating device according to claim 1, wherein
the wheel has a diameter in a range of 50 mm-500 mm,
a horizontal distance between the fixed position of the stop ring and the center axis of the wheel is in a range of 0-240 mm,
a vertical distance between the fixed portion of the stop ring and the center axis of the wheel is in a range of 5 mm-260 mm,
a horizontal distance between a contact position, where the stop ring is in direct contact with the circumferential surface of the wheel by gravity, and the center axis of the wheel is in a range of 0-240 mm, and
a vertical distance between the contact position and the center axis of the wheel is in a range of 10 mm-230 mm.

12. A one-way rotating device, comprising:
a rotatable member configured to rotate about a center axis thereof in a first direction,
a mounting member mounted to the rotatable member, and
a stop mechanism mounted to the rotatable member above the center axis at a fixed position and contacting a circumferential surface of the rotatable member at a position below the center axis to stop the rotatable member from rotating in a second direction opposite to the first direction.

13. The one-way rotating device according to claim 12, wherein the stop mechanism is in direct contact with the circumferential surface of the rotatable member by gravity.

14. The one-way rotating device according to claim 12, wherein the stop mechanism has a U-shaped configuration including
two end portions mounted to the mounting member at the fixed position, and
an intermediate portion connecting the two end portions and in direct contact with the circumferential surface of the rotatable member.

15. The one-way rotating device according to claim 14, wherein the intermediate portion of the stop mechanism has an inner surface configured to directly contact the circumferential surface of the rotatable member to stop the rotatable member from rotating in the second direction.

16. The one-way rotating device according to claim 15, wherein the inner surface of the intermediate portion has an arc shape corresponding to the circumferential surface of the rotatable member.

17. The one-way rotating device according to claim 14, wherein
the rotatable member is divided into a top half and a bottom half by an imaginary horizontal line perpendicular to the center axis, and
the intermediate portion of the stop mechanism is in direct contact with the circumferential surface of the rotatable member at a position within an angle of 60° from the imaginary horizontal line.

18. The one-way rotating device according to claim 17, wherein
the two end portions of the stop mechanism are rotatably mounted to the mounting member at the fixed position in the top half of the rotatable member, and
the intermediate portion of the stop mechanism is in direct contact with the circumferential surface of the rotatable member at the position in the bottom half of the rotatable member.

19. The one-way rotating device according to claim 12, wherein the mounting member includes
a pair of cutouts at the center axis of the rotatable member and receiving a fixing element to fix the mounting member to the rotatable member, and
a pair of openings above the pair of cutouts and receiving two ends of the stop mechanism.

20. The one-way rotating device according to claim 12, wherein
the rotatable member has a diameter in a range of 50 mm-500 mm,
a horizontal distance between the fixed position of the stop mechanism and the center axis of the rotatable member is in a range of 0-240 mm,
a vertical distance between the fixed portion of the stop mechanism and the center axis of the rotatable member is in a range of 5 mm-260 mm,
a horizontal distance between a contact position, where the stop mechanism is in direct contact with the circumferential surface of the rotatable member by gravity, and the center axis of the rotatable member is in a range of 0-240 mm, and
a vertical distance between the contact position and the center axis of the rotatable member is in a range of 10 mm-230 mm.
